(19) United States
(12) Patent Application Publication
(10) Pub. No.: US 2021/0304000 A1
(43) Pub. Date: Sep. 30, 2021

(54) ARTIFICIAL INTELLIGENT AGENT MEMORY SYSTEM MANAGED BY NEURAL NETWORKS

(71) Applicant: Mohammad Rasoolinejad, Evanston, IL (US)

(72) Inventor: Mohammad Rasoolinejad, Evanston, IL (US)

(21) Appl. No.: 17/207,225

(22) Filed: Mar. 19, 2021

Related U.S. Application Data
(60) Provisional application No. 62/994,213, filed on Mar. 24, 2020.

(51) Int. Cl. G06N 3/08; G06N 3/04

(52) U.S. Cl. CPC G06N 3/08; G06N 3/04

(57) ABSTRACT

A method of memory management for an artificial intelligent agent to store, access, decay and delete the memory efficiently. The memory unit in an artificial intelligent agent includes a training memory unit and an event memory unit. The training memory unit stores parameters of the agent's neural networks and is not subject to a decay and a delete routine. The event memory unit stores all information and observations received from the agent's sensor unit. Event memories occupy much more space relative to the training memories. The event memory unit has deep neural networks to classify the memories based on their importance allowing optimization of the memory management procedure and to store, recall, decay and delete the memory efficiently. Classifiers tag the memory based on its category and commonality. As memory belongs to more important categories and uncommon situations, the memory stores in a more accessible manner and decays more slowly.

### CROSS-REFERENCE TO RELATED APPLICATION

This application claims the benefit of priority of U.S. provisional application No. 62/994,213, filed Mar. 24, 2020, the contents of which are herein incorporated by reference.

### BACKGROUND OF THE INVENTION

The present invention relates to memory management, and more particularly to memory management by neural networks.

Neural networks are special machine learning models which use a set of inputs to predict an output. These neural networks are optimized to give the best output from the received input.

Because Artificial Intelligent Agents collect a huge amount of data, stored in a memory, effective management of the data remains a challenge. Typically, the storage, handling, and recalling of the vast information which a learning agent collects, requires significant storage space and a sophisticated recall process. Storing all this data in a high-quality format is not feasible. Besides taking a huge amount of physical memory capacity, it reduces the speed and performance of the agent. In such a case, recalling a specific event will not be efficient and is time-consuming.

Current learning agents collect and store all observed data. One example is Tesla cars which collect and store all data collected from the environment. With current technology, it is not feasible for a learning agent to store all of its data locally and usually the memories are transferred and analyzed on external machines.

However, for general purpose artificial intelligence (AI) applications, machines that have access to their own memory on a local machine is desirable, since storing memories on external machines adds latency.

As can be seen, there is a need for improved memory management in learning agents to reduce the volume of stored data and allocate efficient space for efficient memory recall.

### SUMMARY OF THE INVENTION

In one aspect of the present invention, a memory management system is disclosed for an artificial intelligent agent. The memory management system includes an event memory unit configured to store one or more observed events in a memory space according to the one or more event categories and the uniqueness index. A training memory unit is configured to contain a plurality of operational parameters including parameters of the one or more deep neural networks based on the training data set.

In some embodiments, one or more deep neural networks are configured to analyze the one or more observed events and classify each of the one or more observed events into one or more event categories and assign each observed event a uniqueness index based on a similarity of each observed event to a plurality of previously observed events. An event memory unit is configured as a deep neural network stores the one or more observed events in a memory space according to the one or more event categories and the uniqueness index.

In some embodiments, a categorical classifier neural network QC is configured to classify the one or more observed events within a selected category based on an importance index.

In some embodiments, an event neural network QE is configured to determine the uniqueness index of each of the one or more observed events in the selected category relative to the plurality of previously observed events in the selected category.

In some embodiments, the event neural network QE is configured to train on all the one or more observed events existing in the selected category. The event neural network QE may extract a category specific plurality of key features and a similarity of the one or more observed events with the plurality of previously observed events stored in a category memory space.

In some embodiments, a significance index is determined from the one or more event categories. The significance index and the uniqueness index are used to determine the importance index of the one or more observed events. The importance index may determine one or more of a store routine, a recall routine, a decay routine, and a delete routine. The one or more observed events with a higher importance index store in a more accessible memory location.

In some embodiments, the one or more observed events with higher importance index decay more slowly over a temporal period. The decay routine may impart a reduction of a quality and a size of the one or more observed events over the temporal period. The one or more observed events may be deleted when the quality and the size falls under a predetermined threshold.

In other embodiments, a less similar of the one or more observed events is assigned a higher uniqueness index by the event neural network QE.

In other aspects of the invention, an artificial intelligent agent system includes a sensor unit is configured to receive one or more observed events in an operating environment. An event memory unit configured as a deep neural network, the event memory unit storing the one or more observed events in a memory space according the category and the uniqueness index. A training memory unit configured to contain a plurality of operational parameters including parameters of the one or more deep neural networks based on the training data set. A learning unit neural network QL configured to analyze the one or more observed events and modify the plurality of operational parameters over time based on an analysis of one or more observed events. An actuator unit configured to use the output of the learning unit and do appropriate actions.

These and other features, aspects and advantages of the present invention will become better understood with reference to the following drawings, description and claims.

### BRIEF DESCRIPTION OF THE DRAWINGS

FIG. 1 is a flow chart of the artificial intelligent agent.

FIG. 2 is a flow chart of an event memory.

FIG. 3 is a flow chart of a memory management method.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an artificial intelligent agent memory system that is managed by one or more neural networks. A system of artificial intelligence agent 200 as described herein.

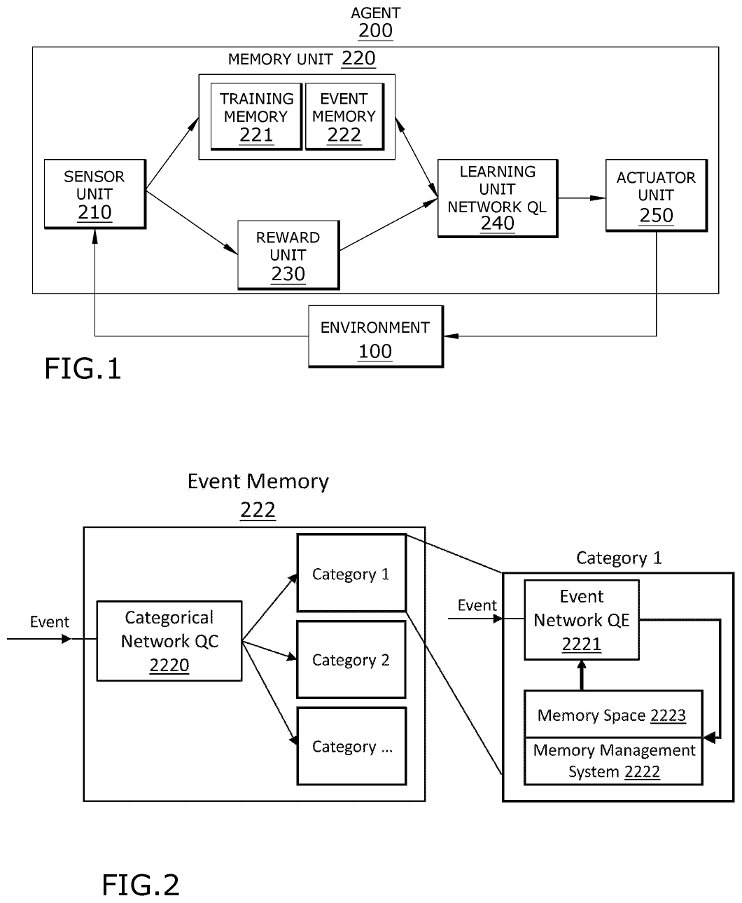

A flow chart of artificial intelligent agent is shown in reference to FIG. 1. The artificial intelligent agent 200 includes a sensor unit 210, a memory unit 220, which includes a training memory unit 221 and an event memory unit 222. The artificial intelligent agent 200 also includes a reward unit 230, a learning unit network QL 240, and an actuator unit 250. The artificial intelligent agent 200 interacts with an environment 100 via the sensor unit 210 and the actuator unit 250.

The reward unit 230 includes a set of analyzers that assign a reward value to the actions of the intelligent agent 200. The reward values can be used to train the intelligent agent through reinforcement learning. Reinforcement learning is a special method to train artificial intelligence and is known to the ones familiar with the subject matter. In this method, the actions of the agent are tagged with positive and negative reward values. The artificial intelligent agent will try to maximize the cumulative reward value by doing more desirable actions. Please note that reinforcement learning is not implemented in all training methods and with no means is intended to limit the invention. When reinforcement learning is utilized, each action or event is associated with a reward value which will be stored together as a tuple. The reward value will be used in the training period and may and may not be deleted afterward.

The actuator unit 250 contains all actuators that artificial intelligent agent uses to interact with environment 100. These actuators can include mechanical arms, speakers, monitors, and the like.

Each artificial intelligent agent 200 is capable of receiving and storing a huge amount of data at every moment. Managing and handling this large amount of data requires sophisticated algorithms and procedures.

In aspects of the present invention, a method is disclosed to efficiently store, recall and delete the data. There are two types of memory the artificial intelligent agent 200 stores. The first kind of memory is a training memory unit 221 containing operational and network parameters.

The artificial intelligent agent 200 includes several deep neural networks arranged in various units. Neural networks are special machine learning models which use a set of input to predict an output. These networks are optimized to give the best output from the received input. The optimal parameters of such networks, and any other necessary information needed for the agent to work properly, are stored in the training memory unit 221. These parameters can be constant or may change over time, as in the case of a reinforced learning agent whose parameters of the learning unit network QL 240 are updated as more data and responses are gathered from environment 100. These sets of data usually do not get much space and can be accessed with a normal memory management routine. The training memory unit 221 is not subject to the decay and delete routine.

The artificial intelligent agent 200 receives a vast amount of data from its environment 100 through the sensor unit 210. The sensor unit 210 observes the artificial intelligent agent's environment 100 and sends the event data to the event memory unit 222. The event observations might or might not be used to train the agent network QL 240. If an observation is used for the training, updated network parameters will be stored in the training memory unit 221 and the event itself will be sent to the event memory unit 222.

As seen in FIG. 2, the event memory unit 222 contains a plurality of neural networks to tag the events. A categorical network QC 2220 network QC is configured to classify the one or more observed events to related categories based on identifying the category specific features. By way of non-limiting example these categories include social, activity, education, work, etc. Each of these categories can have subcategories. The categorical network QC 2220 receives the inputs in all its formats and tags the event to each specific category.

The input from the sensor unit 210 can be in many formats such as video, audio, smell, touch, temperature, etc. Different inputs regarding the same event may be tagged based on an event ID. Each specific event contains a set of these inputs which are categorized together.

An Event is a sequence of the phenomenon that occurred in time which are closely related to each other. For example, the event of “writing a letter” consists of putting the words on the paper and is independent of another event such as “putting the letter in an envelope”. The beginning and end of an event can be tagged by the categorical network QC 2220 or another specialized tagging algorithm. As the category, or subcategory, of observation changes it specifies the end of the event and start of a new one.

After tagging, the events can be stored in a common or a category-specific memory space.

Each category will have a significance index, which is determined by a set of features such as a frequency of queries to that category and category type. For example, an event related to bossiness might get a higher significance index than normal daily routines.

After a new observation is tagged by categorical network QC 2220, it will be passed to an event network QE 2221 The event network QE 2221 determines how unique the event is compared to other events in that category. The event network QE 2221 trains on all the events existing in a certain category and extracts key features and similarities. These features are category-specific. The similarity of the event features is compared with the already existing events in a category memory space 2223. The less similar event gets a higher uniqueness index from the event network QE 2221.

The categorical significance index and event's uniqueness index (called importance factors here) determine the store, recall, decay and delete routine utilized. Events that belong to the categories with a higher significance index and have a higher uniqueness index decay slower in the time. Decay here is referred to any routine to decrease the quality and volume of a memory event. The decay usually is done with the normal procedures to decrease the quality of the video, audio, image, etc. Within each category, the events with higher uniqueness indexes decay slower with respect to other events in the same category. After a set of decays and when the quality has passed a certain threshold, the event gets deleted. This threshold can be different for any category. The freed space is used for storing new observations.

The store, recall, decay and delete are done by memory management system 2222. The memory management system stores and recalls the event in its physical memory location. The algorithms and routines incorporated in memory management system control the decay and delete of the memory events.

Events with the higher significance index and uniqueness index are stored in a more accessible part of the memory. This priority will depend on the memory structure. By way of non-limiting example, if each category is structured as a tree memory system, the event with a higher uniqueness index saves in the available top-level space in the memory tree. The tree memory system is a structured memory system in which the data is stored in a hierarchical manner. This hierarchical storage accommodates for a faster recall of the more important events by a search engine. The first available space might not necessarily be the most optimal space based on the event's importance indices. If the memory hierarchy deviates too much from the optimal state, the memory space can be restructured to restore the optimal state. This restructuring in which events will be reordered based on their importance can be done periodically.

Each specific event consists of one or more instances, such as video, audio, smell, touch, temperature, etc. These instances are analyzed by a type-specific network. All instances of one event share the same category, significance index and the event's uniqueness index. Although, in general, the decay routine might not be the same for each instance. Based on constraints, the decay might be more aggressive than others for one event's instances. Each event's instances might be stored in the same or independent memory spaces. In case the instances of the same event are stored in an independent memory space, each instance stores the location of other instances so they can be immediately accessed.

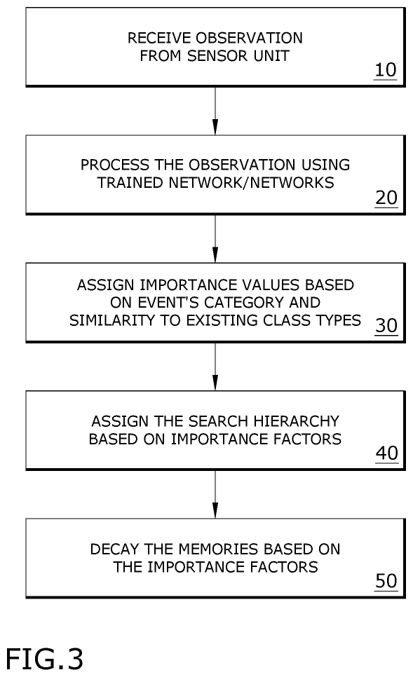

The memory management method to store, recall, decay and delete the memories observed by artificial intelligent agent is shown in reference to FIG. 3. The memory management is based on classification by deep neural networks that receive observation events at 10 received from the sensor unit 210 and tag the observed events based on their category and commonality of observations.

The method processes the observed events at 20 and utilizes a set of deep neural networks that analyze an observed event, classify the observed event into a category and assigns the observed event a uniqueness index based on the similarity of the event to a previously observed event. The observed event includes any input received from the agent's sensor unit 210.

At block 30, the importance values assigned to each observed event based on its category and its similarity to other events sitting in the memory. Each category has a significance index which indicates the importance of that category, and the significance index is assigned based on features such as frequency of queries to that category and category type. The significance index can be predetermined or trained by the neural network.

At block 40, a memory search hierarchy is assigned based on the importance factors. The event category significance index and event uniqueness index determine the event's store, recall, decay and delete routine.

The memories are managed based on the importance factors at block 50. More important and unique events are stored in more accessible memory space for faster recall. The less important and more common events decay and delete faster with respect to more important and less common events. The emptied space due to deletion is used to store new events.

The memory unit's deep neural networks determine importance factors in accordance with all observed events sitting in the agent event memory 222, which are related to the current observed event.

A reduction of the memory's quality and volume may be implemented with a decay. A specific event is erased from the event memory space 2223 when the quality of an event memory falls below a certain decay threshold. The decay threshold can be category specific.

In some instances, a periodic rearrangement of the event memory space 2223 in the memory structure may be executed to obtain an optimal configuration to store, recall, decay and delete the event memory based on its importance factors.

In other embodiments the current values of the parameters of the event memory 222 networks may be updated to reduce the error and to maximize the estimated importance and uniqueness of the observed events.

The method is comprised of updating the parameters of the networks in the training memory unit 221 based on the future observations.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A memory management system, comprising:
an event memory unit configured to store the one or more observed events in a memory space according to the one or more event categories and the uniqueness index; and
a training memory unit configured to contain a plurality of operational parameters including parameters of the one or more deep neural networks based on the training data set.

2. The event memory unit of claim 1, further comprising:
one or more deep neural networks configured to analyze the one or more observed event and classify the each of the one or more observed events into one or more event categories and assign each observed event a uniqueness index based on a similarity of each observed event to a plurality of previously observed events.

3. The event memory unit of claim 2, further comprising:
a categorical classifier neural network QC configured to classify the one or more observed events within a selected category based on an importance index.

4. The event memory unit of claim 3, wherein a significance index is determined from the one or more event categories.

5. The event memory unit of claim 2, further comprising:
an event neural network QE configured to determine the uniqueness index of each of the one or more observed events in the selected category relative to the plurality of previously observed events in that category.

6. The event memory unit of claim 5, wherein the event neural network QE is configured to train on one or more observed events existing in the selected category.

7. The event memory unit of claim 6, wherein the event neural network QE extracts a category specific plurality of key features and a similarity of the one or more observed events with the plurality of previously observed events stored in a category memory space.

8. The event memory unit of claim 2, wherein the event category and the uniqueness index determine the importance index of the one or more observed events.

9. The event memory unit of claim 8, wherein the importance index determines one or more of a store routine, a recall routine, a decay routine, and a delete routine.

10. The event memory unit of claim 9, wherein the one or more observed events with a higher importance index store in a more accessible memory location.

11. The event memory unit of claim 9, wherein the one or more observed events with higher importance index decay more slowly over a temporal period.

12. The decay routine of claim 11, wherein the decay routine comprises a reduction of a quality and a size of the one or more observed events over the temporal period.

13. The delete routine of claim 12, wherein the one or more observed events are deleted when the quality and the size falls under a predetermined threshold.

14. The event memory unit 6, wherein a less similar of the one or more observed events is assigned a higher uniqueness index by the event neural network QE.

15. The training memory unit of claim 1, wherein operational parameters are not subjected to decay and delete routine.

16. An artificial intelligent agent system, comprising:
a sensor unit configured to receive one or more observed events in an operating environment;
an event memory unit configured as a deep neural network, the event memory unit storing the one or more observed events in a memory space according to the category and the uniqueness index;
a training memory unit configured to contain a plurality of operational parameters including parameters of the one or more deep neural networks based on the training data set;
a learning unit neural network QL configured to analyze the one or more observed events and modify the plurality of operational parameters over time based on an analysis of one or more observed events; and
an actuator unit configured to use the output of the learning unit and do appropriate actions.
